(19) United States
(12) Patent Application Publication
(10) Pub. No.: US 2009/0255157 A1
(43) Pub. Date: Oct. 15, 2009

(54) Signboard for Vehicle

(76) Inventor: Young Gon Kim, Gyenggi-do (KR)

Correspondence Address: LAW OFFICES OF CLEMENT CHENG, 17220 NEWHOPE STREET #127, FOUNTAIN VALLEY, CA, 92708, US

(21) Appl. No.: 11/989,897

(22) PCT Filed: Aug. 4, 2006
(86) PCT No.: PCT/KR2006/003064

§ 371 Date: Apr. 7, 2008

(30) Foreign Application Priority Data
Aug. 4, 2005 (KR) 20-2005-0022665

(51) Int. Cl. G09F 21/04; B60R 13/00; G09F 13/00; G09F 13/18

(52) U.S. Cl. 40/546; 40/593; 40/541

(57) ABSTRACT

Provided is a signboard for use in a vehicle, which is installed in the rear portion of the inside of the vehicle to thus deliver a message to a driver or passengers in other vehicles which follow. The vehicle signboard includes a support member having a support plate which is adhered on one side of the inner surface of a rear glass window in the vehicle and a support bar supported by the support plate; a display unit connected to the support member; a motor unit which is fixed to the support member and makes the display unit connected with a rotating member rotate; and a power supply unit which supplies electric power to the motor unit. Accordingly, the vehicle signboard provides an effect of conveying the proper expressions such as thanks and sorry to the drivers and passengers in the other vehicles which follow without obstructing the driver's rear field of view during running.

### TECHNICAL FIELD

The present invention relates to a signboard for a vehicle, and more particularly, to a vehicle signboard which is installed in the rear portion of the inside of the vehicle and is rotated forward or backward by 90° so as to be maintained horizontally at normal times but maintained vertically in use, to thus deliver a message to drivers and passengers in other vehicles which follow, that is, convey the proper expressions such as thanks and sorry to the drivers and passengers in the other vehicles which follow without obstructing the driver's rear field of view during running.

### BACKGROUND ART

In general, various devices and instruments are installed in a vehicle for supplying all kinds of conveniences to an operator and passengers in the vehicle. Among the various devices and instruments, there is a signboard which is attached on the inner side of the rear glass window, for conveying a message to an operator or passengers in other vehicles which follow.

When a vehicle signboard is installed on the inner side of the rear of a vehicle, the former is attached on the latter using an adhesive such as an adhesive tape, or the former is bound to a shelf trim provided at the latter. Accordingly, the vehicle signboard is raised up vertically whenever it is necessary.

However, in the case that the vehicle signboard is attached to the rear glass window using the adhesive tape as described above, the former is always adhered to the latter until the former is detached from the latter. Therefore, a vehicle driver has a considerable disturbing factors to secure a rear field of view. In an extreme case, when the running driver attempts to change the vehicle running line into another, he or she does not predict the distance between the vehicle and the other vehicle which follows, to thereby cause the car accident to occur.

Moreover, in the case that the vehicle signboard is combined with the rear-side shelf trim, and is raised up in use if necessary, the former is not raised up due to the weight of the articles placed on the upper portion of the latter. In this case, in order to raise up the vehicle signboard satisfactorily, the articles placed on the upper portion of the shelf trim should be removed to then make the vehicle signboard raised up.

### DISCLOSURE OF THE INVENTION

To solve the above problems, it is an object of the present invention to provide a vehicle signboard which is installed in the rear portion of the inside of the vehicle and is rotated forward or backward by 90° so as to be maintained horizontally at normal times but maintained vertically in use, to thus deliver a message to drivers and passengers in other vehicles which follow, that is, convey the proper expressions such as thanks and sorry to the drivers and passengers in the other vehicles which follow without obstructing the driver's rear field of view during running, and without having any concern that the vehicle signboard is misoperated by articles which are arranged in the vehicle.

To accomplish the above object of the present invention, according to an aspect of the present invention, there is provided a A signboard for a vehicle, which is installed in the rear portion of the inside of the vehicle to thus deliver a message to a driver or passengers in other vehicles which follow, the vehicle signboard comprising: a support member having a support plate which is adhered on one side of the inner surface of a rear glass window in the vehicle and a support bar supported by the support plate; a display unit connected to the support member; a motor unit which is fixed to the support member and makes the display unit connected with a rotating member rotate; and a power supply unit which supplies electric power to the motor unit.

Preferably, the display unit comprises: an optical guiding central plate made of a synthetic resin material, which plays a role of uniformly scattering the light in whole, and is connected to a rotating member of the motor unit; a diffusion sheet which is respectively installed at both sides of the optical guiding central plate and which uniformly scatters the light which is radiated; a

prism sheet which is installed at one side of the respective diffusion sheets and refracts and condenses the light to thereby heighten a luminance; a wide film which is installed in one side of the respective prism sheets and absorbs and discharges the light to thereby make real pictures or letters clearly indicated; a
lamp which receives electric power from a power supply unit to generate the light of the visible ray; and a combining unit which integrally combines and supports the optical guiding central plate, the diffusion sheets, the prism sheets, the wide films, and the lamp altogether.

Preferably, the lamp is installed in the respective sides of the combined body formed of the optical guiding central plate, the diffusion sheets, the prism sheets, and the wide films.

Preferably, the lamp is a cold cathode fluorescent lamp (CCFL). Preferably, the support bar is formed of two “F”-shaped bars in order to make the display unit freely rotate forward or backward bidirectionally by 90°, to thus be formed of a “D”-shaped bar in whole which protrude forwards from the rear glass window.

Preferably, the display unit is automatically shifted from an on-position which is a vertical state to an off-position which is a horizontal state, and wherein the shifting operation and time is controlled with a wireless remote-controller.

### BRIEF DESCRIPTION OF THE DRAWINGS

FIG. 1 is a perspective view showing a signboard for a vehicle according to the present invention.

FIG. 2 is a perspective view showing the combined state of the signboard for a vehicle according to the present invention, in which the internal structure of a display unit is shown in detail to show a reflective type of light in the display unit for the vehicle signboard.

FIG. 3 is a perspective view of the disassembled state of the display unit in the vehicle signboard according to the present invention.

FIG. 4 is a perspective view of a vehicle where the vehicle signboard according to the present invention has been employed.

### BEST MODE FOR CARRYING OUT THE INVENTION

Hereinbelow, a signboard for a vehicle according to a preferred embodiment of the present invention will be described with reference to the accompanying drawings.

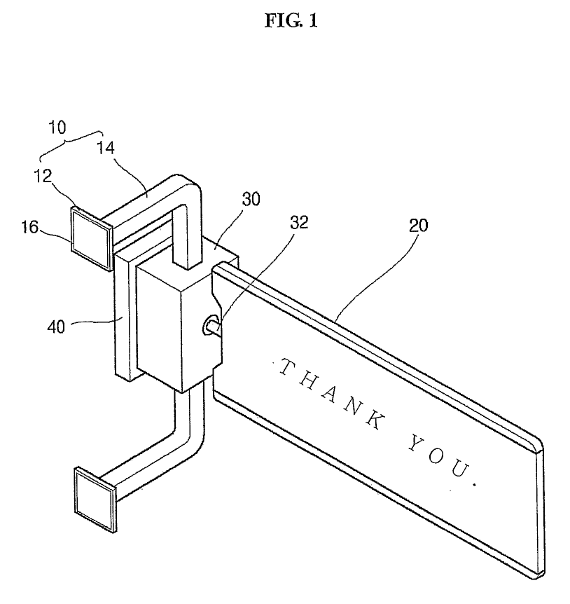

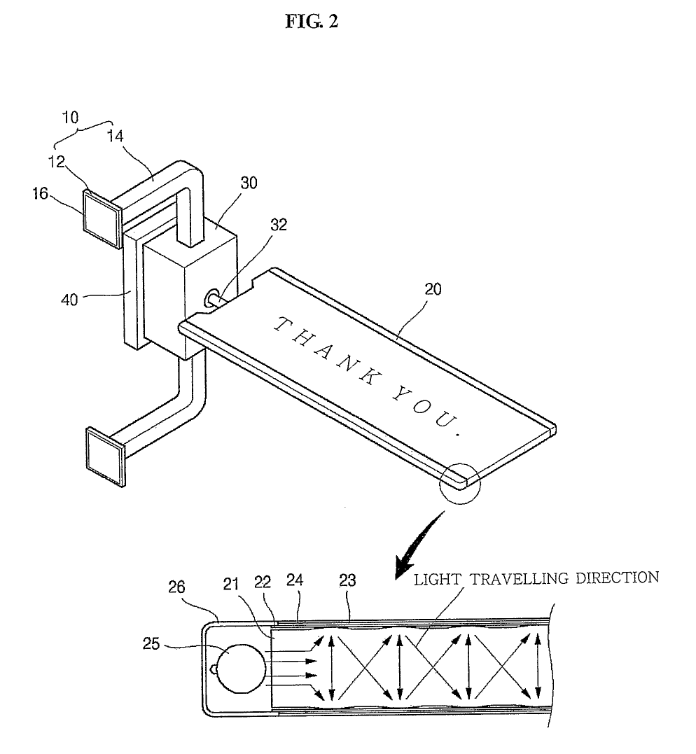

Referring to FIGS. 1 and 2, a signboard for a vehicle according to the present invention includes a support member 10, a display unit 20, a motor unit 30 and a power supply unit 40.

The support member 10 includes at least one support plate 12, for example, two support members 12 in this embodiment, attached to a vehicle and a support bar 14 combined with the support plates 12.

It is preferable that the respective adhered surfaces of the support plates 12 are made of the adhesive tape 16 having a strong adhesion function so that the vehicle signboard mounted on one side of the inner surface of the rear glass window of the vehicle is not detached therefrom even due to the heavy rock and impact applied to the vehicle.

Therefore, the vehicle signboard can be stably used for long by the strong support forces of the support plates 12, at the state where the vehicle signboard has been attached on the rear glass window of the vehicle.

The support bar 14 is formed of two “F”-shaped bars in order to make the display unit 20 freely rotate forward or backward bidirectionally by 90°, to thus be formed of a “3”-shaped bar in whole which protrude forwards from the rear glass window (which is shown in FIG. 4 but has no reference numeral).

One side of one “F”-shaped support bar 14 is combined with the upper surface of one support plate 12 and the other side of the “r”-shaped support bar 14 is connected to the motor unit 30. Likewise, one side of the other ¹T”-shaped support bar 14 is connected to the motor unit 30, and the other side of the other “F”-shaped support bar 14 is combined with the upper surface of the other support plate 12. The motor unit 30 is supported by the support force of the support plates 12.

The “3”-shaped support bar 14 provides a sufficient gap space so that the display unit 20 may rotate quite freely. For this, both ends of two “T”-shaped bars are connected to the motor unit 30 and the rear glass window, respectively, so that the middle portion of the “3”-shaped support bar 14 protrudes forwards from the rear glass window.

That is, both ends of two ¹T”-shaped bars are connected to the motor unit 30 and the rear glass window, respectively, so as to be combined with each other into a “I3”-shaped support bar 14. Accordingly, the “3”-shaped support bar 14 provides a sufficient space so that the display unit 20 can quite freely rotate.

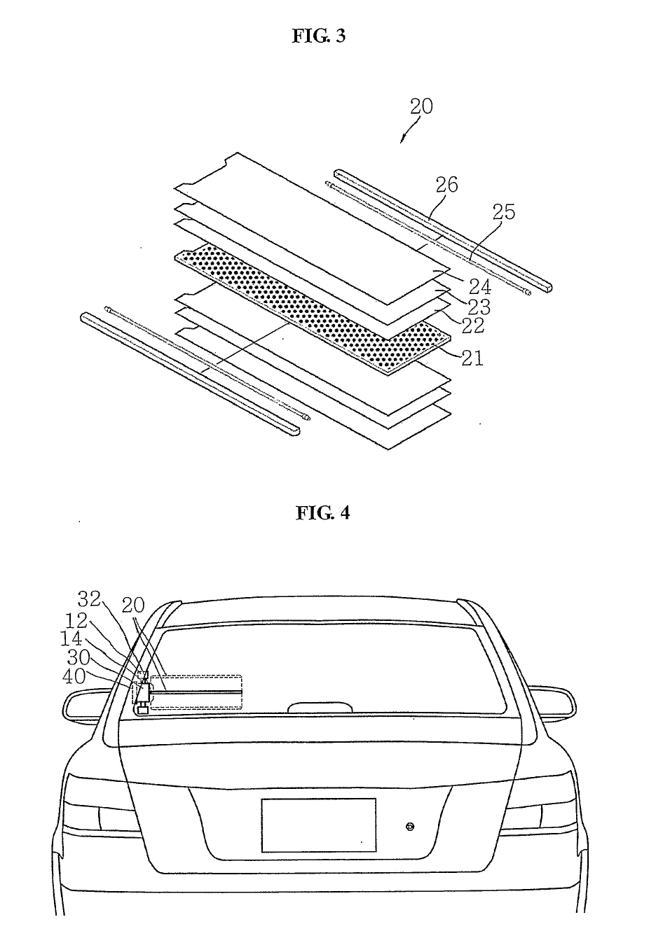

The display unit 20 displays a message thereon. The display unit 20 is connected with a rotating member 32 which is made to rotate by the driving force of the motor unit 30. The display unit 20 is rotated forward or backward by 90° so as to be maintained horizontally at normal times but maintained vertically in use, to thus deliver a message to drivers or passengers in other vehicles which follow, that is, convey the proper expressions such as thanks and sorry to the drivers and passengers in the other vehicles which follow without obstructing the driver's rear field of view during running. The display unit 20 includes an optical guiding central plate 21, diffusion sheets 22, prism sheets 23, wide films 24, lamps 25, and a combining unit 26, as shown in FIG. 3.

The display unit 20 is shifted from an on-position which is a vertical state where a message is displayed, to an off-position which is a horizontal state where the message is not displayed. The shifting operation and time for the display unit 20 is controlled manually with a wireless remote-controller, or automatically by software. Here, it is preferable that the display unit 20 is automatically controlled so as to be shifted from the on-position to the off-position, in the range of five to ten seconds.

The optical guiding central plate 21 is made of a synthetic resin panel such as an ordinary acryl panel. The optical guiding central plate 21 plays a role of the center or bone of the whole message display unit 20, and plays a role of uniformly scattering the light from the lamps 25 in whole, as shown in FIG. 2. The optical guiding central plate 21 is also connected to a rotating member 32 of the motor unit 30, and is made to rotate by rotation of the rotating member 32. The optical guiding central plate 21 includes carved messages such as “thanks” and “sorry” with which a driver tries to express or information about the current state of a vehicle. Otherwise, the optical guiding central plate 21 is made of CCFLs (Cold Cathode Fluorescent Lamps), or the like. The diffusion sheets 22 are respectively installed at both sides of the optical guiding central plate 21 and more uniformly scatter the light which is radiated, to thus play a role of providing soft images of light.

The prism sheet 23 is installed at one side of the respective diffusion sheets in order to prevent a luminance from lowering due to the respective diffusion sheets 22, and refracts and condenses the light from the lamps 25 to thereby heighten a luminance.

The wide films 24 play a role of clearly developing pictures and letters when real pictures of products or foods are printed out and displayed in the department stores or restaurants. The wide film 24 is installed in one side of the respective prism sheets and absorbs and discharges the light to thereby make real pictures or letters to be conveyed clearly indicated. The lamp 25 is installed in the respective sides of the combined body formed of the optical guiding central plate 21, the diffusion sheets 22, the prism sheets 23, and the wide films 24. The lamps 25 receive high-voltage electric power from a power supply unit 40 to generate the light of the visible ray. Preferably, the lamps 25 are cold cathode fluorescent lamps (CCFLs) having an excellent brightness of light which are used for a general LCD (Liquid Crystal Display) monitor, or a small-sized advertizing board.

In the present invention, the display unit 20 is newly formed by combining the diffusion sheets 22, the prism sheets 23, and the wide films 24, to thus obtain clearer and softer light development.

The combining unit 26 integrally combines and supports the optical guiding central plate 21, the diffusion sheets 22, the prism sheets 23, the wide films 24, and the lamp 25 altogether (see FIG. 2).

The motor unit 30 is fixed by the support bar 14 of the support member 10. The motor unit 30 receives electric power from the power supply unit 40, and makes the display unit 20 connected with the rotating member 32 rotate whenever necessary.

The power supply unit 40 receives electric power from a main power supply unit (not shown) in a vehicle and supplies electric power to the motor unit 30, which includes a PCB (Printed Circuit Board) and an inverter. Here, it is preferable that the distance between the motor unit 30 and the power supply unit 40 should be minimized in order to minimize the volume of the vehicle signboard.

The vehicle signboard can be operated by manipulation of switches attached on a front instrument board in the inner portion of a vehicle by a driver or passenger. Otherwise, the vehicle signboard can be operated using a wireless remote-controller, irrespective of the driver's or passenger's position, to thereby enable the driver or passenger to quite conveniently use it.

The operation of the vehicle signboard having the above-described structure will follow.

The vehicle signboard according to the present invention can deliver the proper expressions such as “thanks” or “sorry” to the drivers and/or passengers of the other vehicles, at the state where a vehicle driver changes a vehicle running line to pass the side lane ahead of other vehicles, or gives the unpleasant feeling to the drivers and/or passengers of the other vehicles. Moreover, the vehicle signboard according to the present invention can inform the drivers and/or passengers of the other vehicles of situations generated in the vehicle. For this purpose, the vehicle signboard according to the present invention can be driven by a message button mounted on an instrument panel which is located in front of the vehicle, or a wireless remote-controller.

The vehicle signboard according to the present invention is maintained horizontally in order to minimize the part which covers the rear field of vision and secure a rear field of view of the vehicle driver, at normal times. According to manipulation of the switch or the wireless remote-controller, the vehicle signboard is made to rotate forward or backward bidirectionally by 90° and stand upright. At the same time, the lamp 25 is turned on to thus deliver the driver's intention exactly and clearly to the drivers and/or passengers in the other vehicles.

If it is judged that the above-described proper expressions have been delivered to the drivers and/or passengers in the other vehicles, the driver turns off the vehicle signboard using the switch or the wireless remote-controller. Accordingly, the display unit 20 is shifted from the vertical state to the horizontal state. Otherwise, the display unit 20 is automatically shifted back to the horizontal state by software after a predetermined time has lapsed.

Here, it is preferable that the display unit 20 is automatically controlled so as to be shifted from the on-position to the off-position, in the range of five to ten seconds.

As described above, in order to minimize the portion which can cover the driver's filed of vision and thus secure a wide rear filed of view, the vehicle signboard is returned to the off-position, that is, the horizontal state. As described above, the present invention has been described with respect to the particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention provides to a signboard for a vehicle which is installed in the rear portion of the inside of the vehicle and is rotated forward or backward by 90° so as to be maintained horizontally at normal times but maintained vertically in use, to thus deliver a message to drivers and passengers in other vehicles which follow, that is, convey the proper expressions such as thanks and sorry to the drivers and passengers in the other vehicles which follow without obstructing the driver's rear field of view during running, and without having any concern that the vehicle signboard is misoperated by articles which are arranged in the vehicle. Moreover, the vehicle signboard according to the present invention can be driven the switch or wireless remote-controller so as to be easily driven wherever it is located in the vehicle.

What is claimed is:

1. A signboard for a vehicle, which is installed in the rear portion of the inside of the vehicle to thus deliver a message to a driver or passengers in other vehicles which follow, the vehicle signboard comprising: a support member having a support plate which is adhered on one side of the inner surface of a rear glass window in the vehicle and a support bar supported by the support plate; a display unit connected to the support member; a motor unit which is fixed to the support member and makes the display unit connected with a rotating member rotate; and a power supply unit which supplies electric power to the motor unit.

2. The vehicle signboard according to claim 1, wherein the display unit comprises: an optical guiding central plate made of a synthetic resin material, which plays a role of uniformly scattering the light in whole, and is connected to a rotating member of the motor unit; a diffusion sheet which is respectively installed at both sides of the optical guiding central plate and which uniformly scatters the light which is radiated; a prism sheet which is installed at one side of the respective diffusion sheets and refracts and condenses the light to thereby heighten a luminance; a wide film which is installed in one side of the respective prism sheets and absorbs and discharges the light to thereby make real pictures or letters clearly indicated; a lamp which receives electric power from a power supply unit to generate the light of the visible ray; and a combining unit which integrally combines and supports the optical guiding central plate, the diffusion sheets, the prism sheets, the wide films, and the lamp altogether.

3. The vehicle signboard according to claim 2, wherein the lamp is installed in the respective sides of the combined body formed of the optical guiding central plate, the diffusion sheets, the prism sheets, and the wide films.

4. The vehicle signboard according to claim 2, wherein the lamps are cold cathode fluorescent lamps (CCFLs).

5. The vehicle signboard according to claim 2, wherein the support bar is formed of two “F”-shaped bars in order to make the display unit freely rotate forward or backward bidirectionally by 90°, to thus be formed of a “3”-shaped bar in whole which protrude forwards from the rear glass window.

6. The vehicle signboard according to claim 1, wherein the display unit is automatically shifted from an on-position which is a vertical state to an off-position which is a horizontal state, and wherein the shifting operation and time is controlled with a wireless remote-controller.
